(19) United States
(12) Patent Application Publication
(10) Pub. No.: US 2016/0328745 A1
(43) Pub. Date: Nov. 10, 2016

(54) Method and Apparatus for Routing Including Advertiser Waypoints

(71) Applicant: Ford Global Technologies, LLC, Dearborn, MI (US)

(72) Inventors: Douglas Raymond Martin, Canton, MI (US); Mark Anthony Rockwell, Wyandotte, MI (US)

(21) Appl. No.: 14/703,950

(22) Filed: May 5, 2015

(51) Int. Cl. G06Q 30/02

(52) U.S. Cl. CPC G06Q 30/0257; G06Q 30/0261; G06Q 30/0273

(57) ABSTRACT

A system includes a processor configured to receive a destination and advertiser selection criteria. Further, the processor is configured to determine an advertiser route, including an advertiser location, alternative to a fastest or shortest route, based on the advertiser selection criteria. The processor is additionally configured to present the advertiser route to a vehicle occupant. The processor is also configured to receive an occupant decision of either acceptance or avoidance of the advertiser route and augment an eventual trip cost based on whether the advertiser route was accepted or avoided.

### TECHNICAL FIELD

The illustrative embodiments generally relate to a method and apparatus for routing including advertiser waypoints.

### BACKGROUND

Many people find it convenient to utilize vehicles on a short-term basis. Whether it is a cab service, an on-demand application-based service such as UBER™, a short-term (i.e. hourly or daily vehicle rental) usage, or even hiring or requesting to use an autonomous vehicle driven by a computer, the models for short-term vehicle usage are constantly growing and evolving.

As would be expected, usage of vehicles in any of these exemplary scenarios comes with a cost. In the models where a driver is included with the vehicle, the driver typically captures some portion of the cost. In the rental scenarios, the entity that owns the vehicle captures the revenue. Since vehicles are expensive to own and maintain, especially when used significantly throughout the day, additional sources of revenue for an owner/driver may be desired. Alternatively, ways to offset the cost to a rider may be similarly desirable. Any extra revenue resulting from a journey can flow directly to the owner/operator, to the rider or be shared in some manner between all parties involved.

In one current model, a request for route information to a destination is received by a route processing module. Available routes to the destination are determined in response to receiving the request. It is determined, for at least one available route to the destination, whether the available route provides proximity to at least one targeted advertisement. At least one available route to the destination is provided upon determining that the available route provides the proximity to the targeted advertisement.

### SUMMARY

In a first illustrative embodiment, a system includes a processor configured to receive a destination. The processor is also configured to receive advertiser selection criteria. Further, the processor is configured to determine an advertiser route, including an advertiser location, alternative to a fastest or shortest route, based on the advertiser selection criteria. The processor is additionally configured to present the advertiser route to a vehicle occupant. The processor is also configured to receive an occupant decision of either acceptance or avoidance of the advertiser route and augment an eventual trip cost based on whether the advertiser route was accepted or avoided.

In a second illustrative embodiment, a system includes a processor configured to receive a destination. The processor is also configured to calculate a direct route to the destination. The processor is further configured to find potential advertisers with a predefined proximity to the direct route. Also, the processor is configured to select an advertiser from the potential advertisers for inclusion in an advertiser route. The processor is additionally configured to present the advertiser route to a vehicle passenger with an option to opt-out of the advertiser route and increase a travel cost if the passenger elects to opt-out of the advertiser route.

In a third illustrative embodiment, a system includes a processor configured to receive a destination. The processor is also configured to find advertisers with a predefined proximity to a direct route to the destination. Further, the processor is configured to select an advertiser from the found advertisers for inclusion in an advertiser route. The processor is additionally configured to present the advertiser route to a vehicle passenger with an option to elect the advertiser route. The processor is also configured to offer a stop at an advertiser associated location when a vehicle reaches the advertiser associated location and decrease a travel cost if the passenger elects the advertiser route.

### BRIEF DESCRIPTION OF THE DRAWINGS

FIG. 1 shows an illustrative vehicle computing system;

FIG. 2 shows an illustrative example of a route determination process;

FIG. 3 shows an illustrative example of an alternative route presentation process;

FIG. 4 shows illustrative examples of exemplary route modification displays;

FIG. 5 shows an illustrative example of an advertiser selection process;

FIG. 6 shows an illustrative example of an advertisement suitability determination process; and

FIG. 7 shows an illustrative process for routing including advertising.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

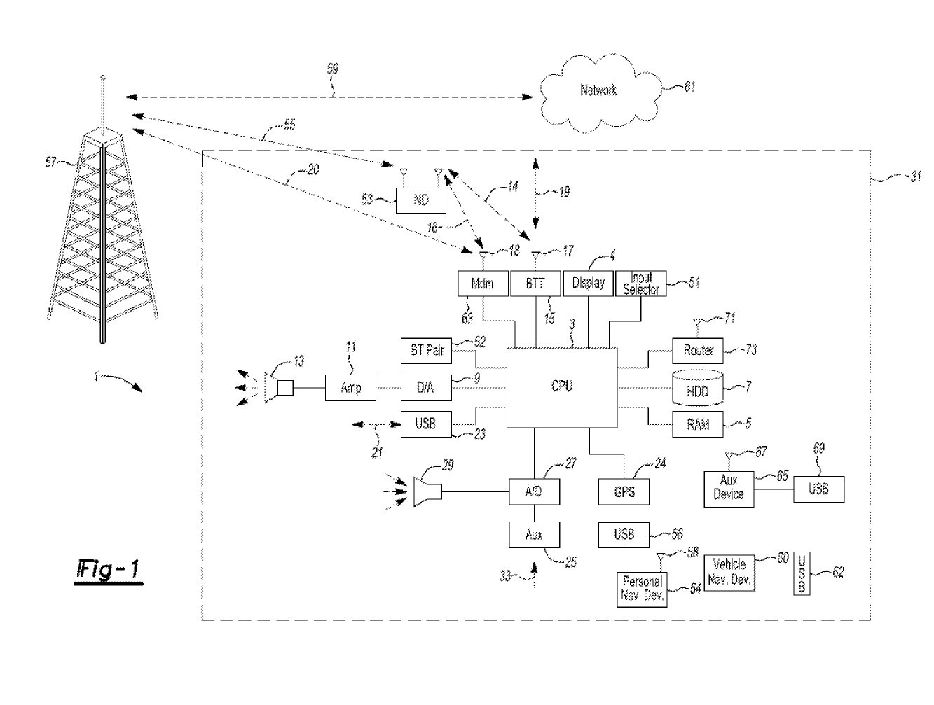

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data plan associated with the nomadic device, it is possible that the data plan allows for broadband transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Maintaining a vehicle utilized frequently for travel can be expensive. Further, it is anticipated that, at least initially, autonomous vehicles may also be expensive to own. Groups of people who share or regularly rent vehicles may look for cost reducing opportunities, that don't greatly impact reliably arriving at a destination on time. Vehicle owners may also look for ways to defray the upfront and upkeep costs of owning a vehicle that is frequently used for travel.

The illustrative embodiments present examples of cost-reduction that can apply to passengers, vehicle renters, vehicle drivers and vehicle owners. In exchange for a fee, routing to a destination can be taken past one or more advertiser locations. In some models, a passenger can accept an alternative route in exchange for a reduction in cost. In other models, the passenger may opt-out of the alternative route for a more direct route in exchange for an increased cost. Depending on which party to whom the benefit of the route flows, decisions about which route to take can increase or decrease cost to that party. Benefits derive from routing past advertiser locations, and the decision to collect or avoid those benefits can be made by the passenger, several passengers, a driver, a vehicle owner or any combination, depending on the implementation.

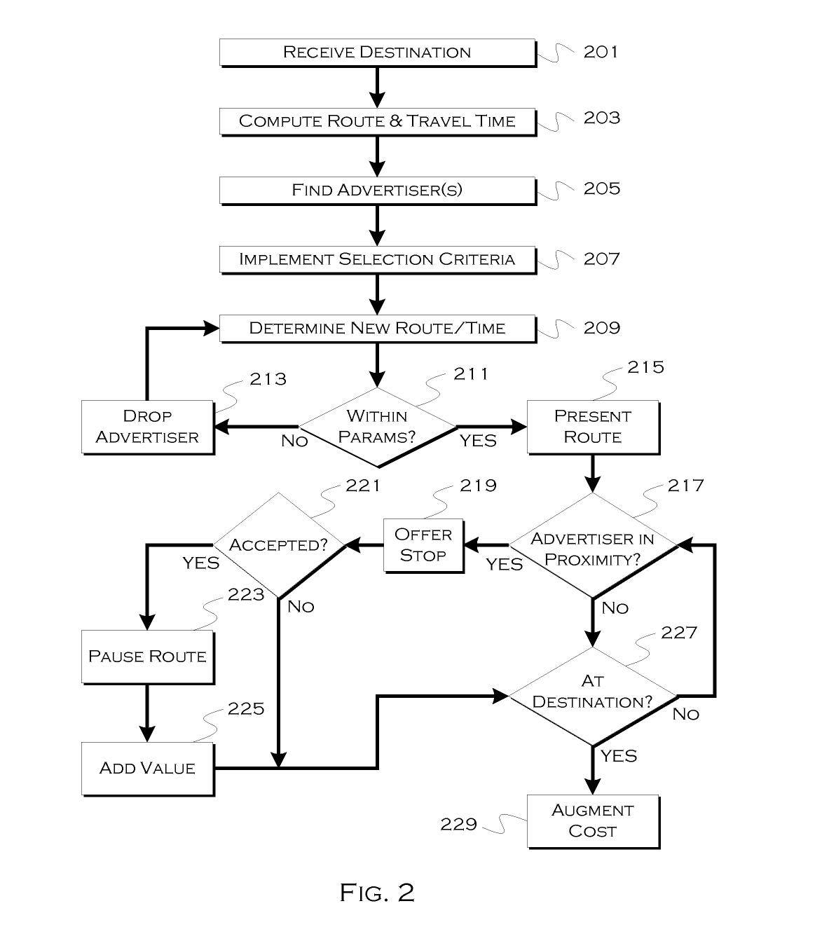

FIG. 2 shows an illustrative example of a route determination process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example shown in FIG. 2, the process first receives a destination 201. Whether this is a destination input by a driver (such as in a cab-type scenario), a destination input by a renter-driver, a destination provided to an autonomous vehicle or any other sort of received destination, the destination indicates at least one stop on a journey. The process, in this example, then computes a route and travel time 203. An initial route and travel time may be useful for both finding advertisers in proximity to the initial route (which may be, for example, without limitation, a least-cost route, a least-time route, a least-fuel route, etc.) and for determining an allowable time deviance. For example, if initial route R_{I} is projected to take 14 minutes, and a rider has a tolerance of 25 total minutes before arriving, then the process may find all advertisers that cause no more than an approximate 11 minute (25 permissible minutes−14 projected minutes) delay in the route. In other examples, the advertisers may be found based on distance proximity to the route, instead of temporal proximity.

Once the destination and initial route is known, the process may find one or more advertisers within a suitable proximity to the route 205. Advertiser selection can be based on a distance or temporal proximity, the suitability of which could be defined by occupant input or a saved occupant profile. Advertiser selection may also, for example, be based on a value ascribed to the detour, e.g., if a detour is worth less than N dollars, the detour may be avoided, or, conversely, if a detour is worth at least M dollars, the detour may be taken. This can provide a variety of routing options and the determination about a possible detour could even be done before entering the vehicle.

For example, a business person with a high income might only care about arriving at a location via the fastest possible route. On the other hand, a college student with no or low income may need to travel some distance for the cheapest possible cost, but may not care about how long the trip takes. In each example, the needs of the traveler can be accommodated. Travelers could set their route deviance preferences in a profile (saved on a phone or in the cloud, for example), include the preferences with a vehicle request, or input the preferences once in the vehicle. The vehicle may also simply provide route alternative options for passenger selection based on some predefined deviance criteria. Based on any desired or known selection criteria, possible advertisers can be sorted 207.

For example, the system may gather all advertisers within either 10 minutes or 2 miles of a given route (based on some predefined criteria defined by an implementer). Then, the passenger specific criteria may be applied to further sort the advertisers. In other examples, initial selection may be performed by the passenger criteria, and then refined (if needed) by other criteria, such as driver constraints or a next-passenger need for a vehicle (i.e., if the vehicle is needed in 30 minutes to fulfill another request). For example, on a busy day, a driver/owner may not want too much deviance from fastest routes, because of the increased value of additional passengers, but on a slow day, any level of passenger acceptable deviance may be desirable. The system can be fine tuned on a daily or even hourly basis to accommodate the needs of any or all involved, and to maximize possible revenue and advertiser credits based on current conditions.

Once any sorting/filtering of advertisers has been performed 207, the process can determine one or more new routes incorporating some or all of the advertisers 209. For any of these routes that fall within the parameters (i.e., driver/owner/passenger specifications for acceptable alternatives) 211, the process can present those routes to the occupant or driver for acceptance 215. If there are one or more routes that fall outside of parameters or if no routes are acceptable (depending on the implementation and desire for alternative routes), the process can drop an advertiser 213 from one or more routes to speed up travel time or reduce distance deviance and recalculate the acceptability of the revised travel routes.

Once the desired number of acceptable routes has been presented to the occupant/driver/traveler, the process can wait until the vehicle is in proximity to one or more advertisers 217. That is, in addition to presenting an advertisement related to a particular merchant, the route will travel past the merchant location and thus increase the value of the advertisement. In this example, the process may offer a stop 219 at the advertiser location, which could also result (if the stop is accepted) in some additional benefit to a passenger, driver/owner or both.

For example, if the advertiser was a drive-through restaurant, the process may cover the incremental cost of waiting for food, as well as provide a coupon for a passenger. Or, for example, the process may provide some base benefit to the owner/driver for each stop. The benefit may also be merchant dependent, varying in value in accordance with different merchants (e.g. a restaurant may only provide $1 in additional value, whereas a jewelry merchant may provide up to $50 in value depending on purchase made).

If the stop offer is accepted 221, the process may pause the route 223 and add any additional value to the appropriate parties 225 in accordance with any value assigned to the actual stop. Otherwise, the process may continue to seek out advertiser locations as the vehicle travels until the vehicle reaches a destination 227. Once the destination is reached, any final cost/value augmentations may be performed.

In one non-limiting example, a cab driver may pick up an occupant with 30 minutes to reach a destination, and an initial route may only be a 15 minute route. This provides for up to 15 minutes of possible deviance. The advertiser selection process may find two food merchants along a first alternative route, each willing to supplement $1 of cost if the vehicle is routed past the merchant. The merchants may also provide an additional $1 of waiting time supplement if a stop is selected. A second alternative route may include a florist, who will provide $2 of supplemental cost and an additional $5 of waiting time supplement.

If the passenger is advertiser agnostic at the time of the ride (i.e., doesn't care about eating or buying flowers), either alternative route may be acceptable and selected. If the passenger wants either of the possible services (i.e., to eat or buy flowers), the appropriate route may be selected. When the vehicle passes the appropriate location, the passenger may elect a stop and, if goods are purchased, the supplemental value may also be provided.

In another example, the value of the advertisements may accrue directly to the driver (or vehicle owner in a rental or use scenario, such as with an autonomous vehicle). Thus, the initial route may be set to find a route that includes at least one advertiser, and the occupant can chose to “ignore” the initial route in exchange for a faster route. In this example, the occupant may cover the premium that would have been paid by the advertisers in exchange for the faster route. Other suitable divisions of value from the advertiser-including routes may also be utilized.

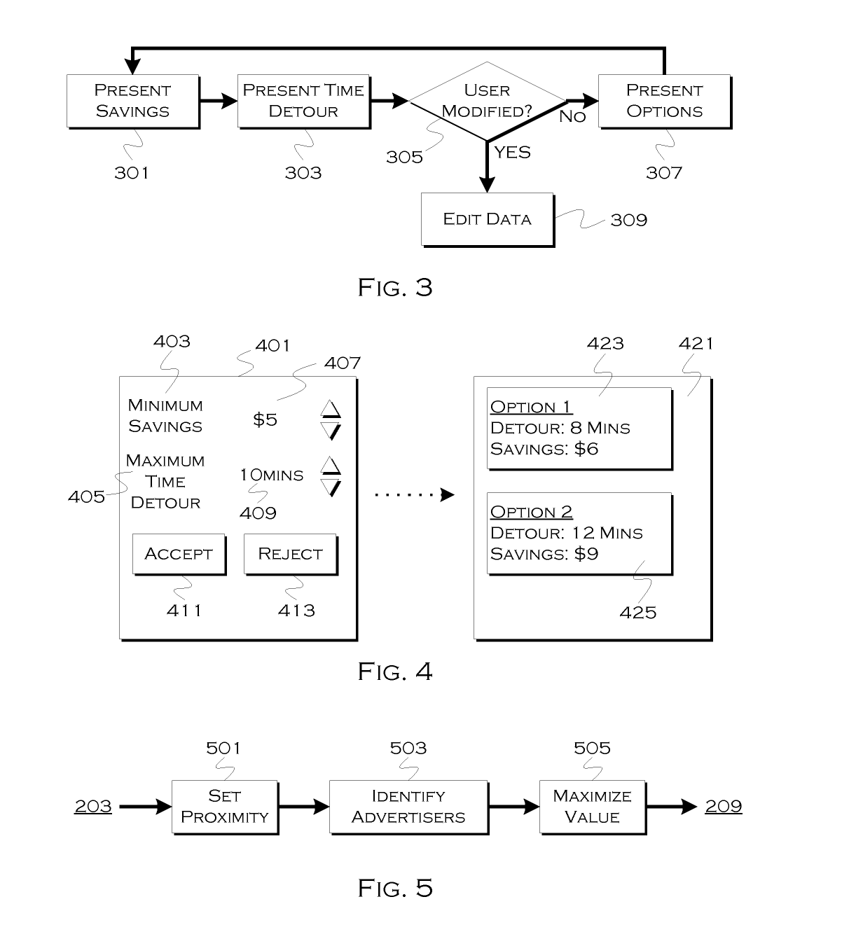

FIG. 3 shows an illustrative example of an alternative route presentation process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process may present one or more alternative routes to a primary route, which include or exclude advertisers, and detail the benefit or cost of accepting or avoiding the advertiser-including route. For each route, a savings (e.g. benefit, cost, etc.) may be presented 301. In addition a time detour 303 may be presented, showing how much slower (for longer routes) or faster (for shorter routes) of a route will result from a given selection.

For example, if a model where benefit was derived from taking a slower route with advertisers along the way is used, then an alternative route may show that two food merchants are present along a five minute detour with a value of $2 for the re-route ($1 per merchant) as well as an additional value of $1 if a stop is made. If the model where the advertiser route was the default route is used, the alternative route may show that a five minute faster arrival may be achieved in exchange for a $2 premium for avoiding the advertiser-including route.

Also, in this example, the user (driver, occupant, etc. as appropriate) may modify the route. For example, it may be possible to drop the more route-deviant of the two advertisers in exchange for foregoing or spending (depending on the model) $1. If a first advertiser was 1 minute from the fastest route and the second advertiser was 4 additional minutes from the fastest route, the second advertiser could be dropped for a loss/cost of $1 and a 4 minute faster projected arrival. The route is then edited in accordance with requested changes 307 and the resulting route is presented. Provided that any necessary turns are not yet passed, this amendment of route alternatives may proceed while a vehicle is in progress, to avoid unnecessary delays while the passenger or driver decides on which route is preferred.

In this example, following any amendments, the final route options are then presented for selection by the appropriate party 309.

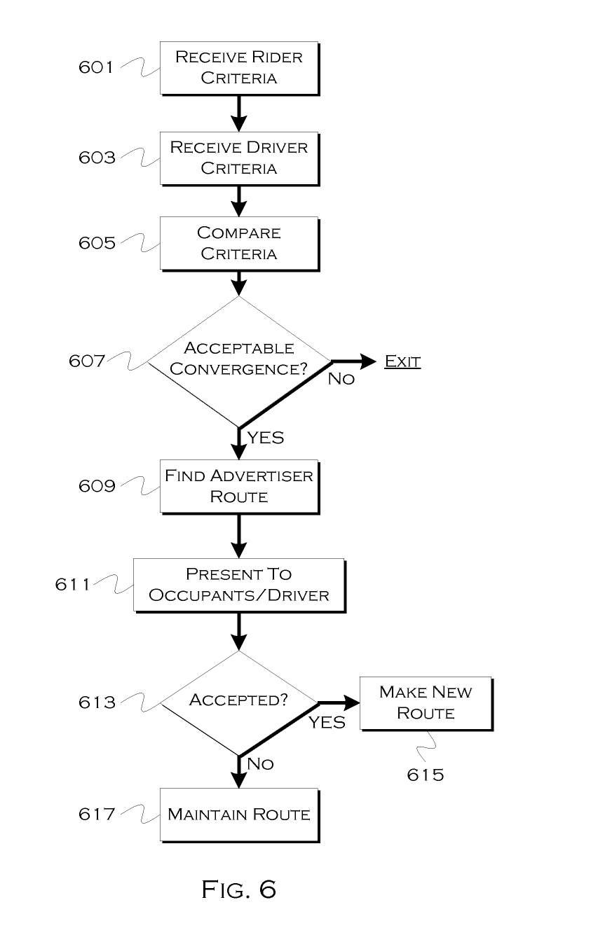

FIG. 4 shows illustrative examples of exemplary route modification displays. These are non-limiting examples of what could be presented to a user on a phone, computer, in-vehicle display, etc. They are intended to exemplify the concepts described herein, and are not intended to limit the presentation of these concepts thereto.

Screen 401 shows an illustrative initial display that allows a passenger, driver, owner, etc. to define some set of base preferences, either for a user profile or for a particular journey. In this example, a minimum savings 403 is definable, wherein the value 407 is adjustable via the up and down arrows. Also, a maximum time detour 405 is displayed, again with an adjustable value 409. These parameters may be usable by an occupant or driver, and additional parameters may be added or removed as appropriate. Once a suitable set of parameters is defined, the user can accept the parameters 411. In this example, the user can also elect to “reject” any route alternatives, which essentially selects the fastest route avoiding all gain or accruing all advertiser avoidance cost.

Following a suitable selection of route options as appropriate, the user may then be presented with screen 421, showing two (in this example) alternative route options 423 and 425. The options (in this example) detail the time detour and a savings value. It would also be possible to show additional information as desired, such as, for example, the nature of the advertisements along the detour.

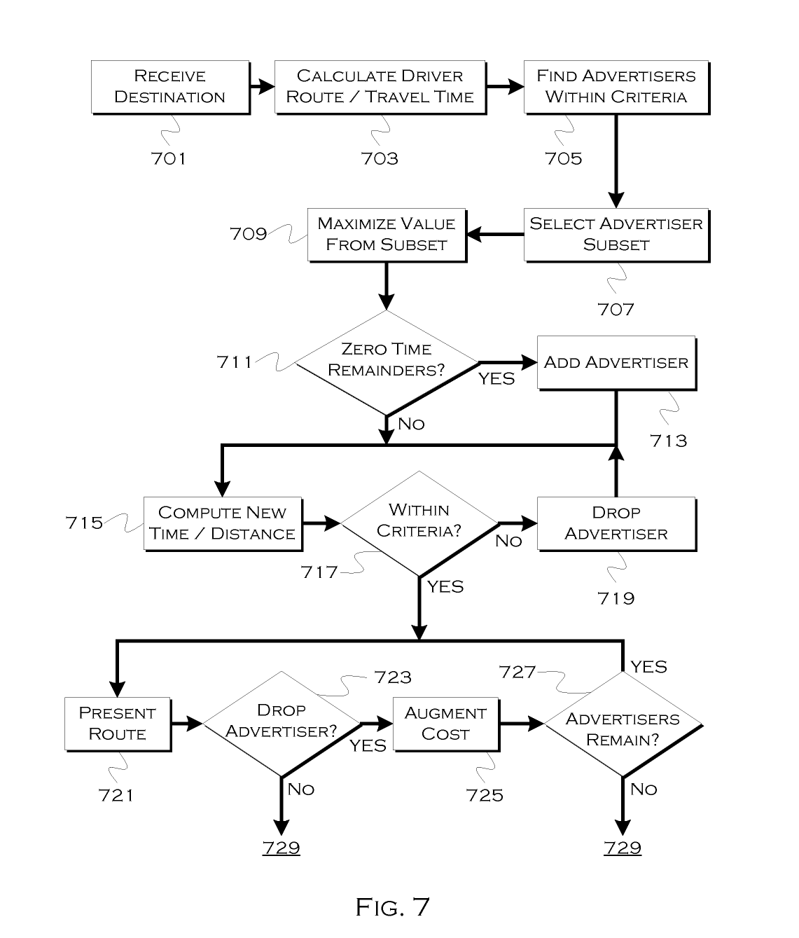

FIG. 5 shows an illustrative example of an advertiser selection process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, it is contemplated that there may be a variety of possible advertiser-including routes (such as in a crowded city). Accordingly, it may be desirable to select an alternative that maximizes value from a large number of alternatives. Even if only a few options are available, however, the optimization could still be performed.

Once a physical or temporal proximity for deviance is set 501, the process may identify all advertisers that fall within the defined boundaries 503. For example, on a three mile journey through New York City, it may be possible to encounter fifty potential advertisers. From those fifty, a route that provides a maximum value within acceptable deviance constraints may be selected 505. This could be based on, for example, without limitation, base value associated with each advertiser, a likelihood of stop vs. a value of stop, and even based on known occupant habits defined in a user profile or occupant preferences for a particular journey. For example, in the absence of occupant information, it may be generally 20% likely that food stops are used, for a value of $1 each, and 0.5% likely that a jewelry merchant stop is used, for a value of $20, giving the food stop an estimated value of $0.20 and the jewelry merchant stop an estimated value of $0.10. If the occupant indicates a preference for food, however, the likelihood of a food stop may increase to 80%, increasing the projected stop value to $0.80. If the occupant indicates a preference for jewelry, the likelihood of a jewelry stop may increase to 25%, giving the jewelry stop a projected value of $5.

By accommodating for known preferences as well as any generally observed likelihood of stop at a given advertiser, and by accommodating for occupant and driver/owner acceptable deviances of time and distance, a maximum value route can be projected. In the pay-to-avoid-detour model, the occupant can be given the option to take a fastest route in exchange for payment of the projected value of the alternative route. This avoidance cost may also be modified as appropriate, since some value may derive to the driver/owner from getting the vehicle back in service for a new customer more quickly.

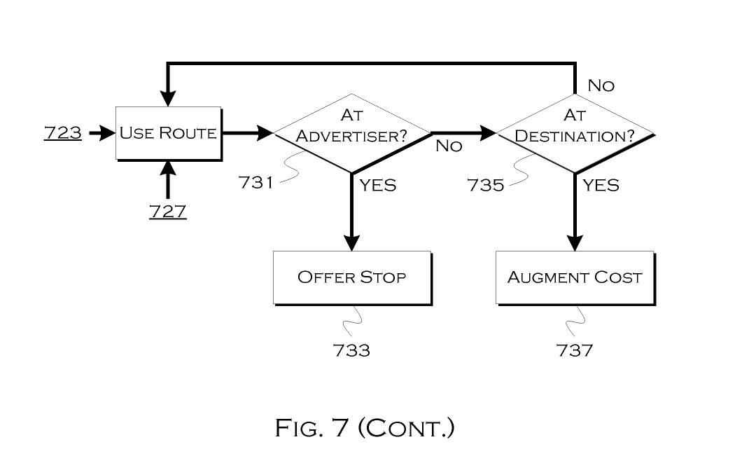

FIG. 6 shows an illustrative example of an advertisement suitability determination process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, an occupant may have some present criteria (in a profile and/or with respect to a journey) that defines a willingness to reroute for benefit or pay to avoid detours. This criteria are received 601 by the process at a suitable time. Also, the driver/owner may have some criteria set defining acceptable detours, which is also received 603. In addition to criteria similar to the occupant's, the driver/owner may want to avoid low value detours of certain distances (due to fuel costs, for example), or may want to avoid low value detours of certain times in high passenger volume times of day, etc.

Here, the two sets of criteria are compared 605 to find any suitable correspondences between the two that meet both criteria sets (assuming both parties set criteria). For example, a passenger may be willing to take up to 15 minutes of detours in exchange for a minimum of $3 in value. A driver/owner may be willing to permit up to 10 minutes of detours in exchange for a minimum of $2 in value. Thus, the criteria would be set at 10 minutes of detours in exchange for at least $3 in value to accommodate all parties. In other examples, the passenger or driver/owner criteria may trump, based on the model used (e.g., driver preferences are always taken over passenger, or vice versa, unless only one set is present).

When any suitable convergence or definition of criteria is found 607, the process will then utilize the convergence (or lone criteria set) to find a route including advertisers 609. Any number of routes meeting the criteria could then be presented for acceptance 611. In one example, only a top value (or a finite number of highest value) routes may be presented. If any of the presented routes is accepted 613, the accepted route becomes the new route 615. Otherwise, a present route may be maintained 617. Whether the present route includes advertisers or represents a fastest route may depend on the model used. In the pay-to-avoid-advertiser model, the rider may be presented with a cost to take the fastest route, which is representative of or based in some way on the value to the driver/owner of taking the advertiser-including route.

FIG. 7 shows an illustrative process for routing-including-advertising. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a route including advertisers is selected to provide value to a driver/owner. The occupant/passenger can chose to avoid some or all of the route in exchange for some level of premium. This is just another non-limiting example of a possible process involving aspects of the illustrative embodiments.

In this example, the eventual destination is received 701. As noted previously, this could be input locally or remotely as appropriate. Then, in this process, a direct route and travel time is computed based on a least distance model, least time model, or other suitable direct route model 703.

Once the direct route is known, the process finds any available advertisers that meet some predefined criteria 705. For example, based on a time of day or volume of potential customers, the driver/owner could set the deviance accordingly. In one example, the deviance is based on the total distance or time of route (e.g., X % of total), but fixed deviances (e.g., Y miles or Z minutes) could also be used. All advertisers, in this example, within the suitable criteria are discovered and then selection is made from these advertisers.

In this example, selection proceeds with first selecting N advertisers (in this example 5 advertisers) that add the least amount of time to a trip. In other examples, the selection could start with advertisers that add the most amount of value to a trip, for example. Once some subset of advertisers is selected 707, the process then selects a further subset, in this example, that maximizes the value from that subset 709 (in this example, 3 highest value of the 5 advertisers are selected). Also, in this example, it is determined if any of the remaining (here 2 advertisers) advertisers can be added to the route with zero time increase 711. If so, that or those advertisers are also selected 713. This allows for additional value with zero-time increase.

Once a final list of advertisers is selected, a new route with new time and distance is determined 715. If the new route is within some total acceptable deviance 717 (time/distance, for example, in this example it would be adding no more than 30% travel time), the process continues with opt-out presentation 721. Otherwise, an advertiser adding the greatest deviance (or a least cost advertiser, or some combinatorial determination) is dropped 719 and the new route is calculated.

Once a route within the total suitable deviance is determined, the process presents the route to the occupant for opt-out options 721. That is, the presentation may ask “are you willing to pay $N to decrease travel time by X minutes?” If the occupant wants to drop an advertiser 723 and pay the premium, the process augments the total cost by the premium 725 (which may correspond to the value or some fraction of the value of the dropped advertisement-including portion of the route) and then, if advertisers remain 727, the occupant is given the option to opt-out of additional advertisements.

Once the occupant has opted out of any desired advertising detours, the process utilizes the remaining route 729. If the vehicle passes an advertiser location 731, the process may offer a stop at the advertiser 733. This stop, as previously noted, may accrue some additional value to either the occupant, driver/owner, or both. This stop-offering continues as appropriate until the vehicle reaches the destination 735, at which time any appropriate adjustments are made to the final cost 737. This can include, but is not limited to, opt-out costs, premiums for stops, occupant derived value from accepting advertisement-including detours, etc.

Through use of the illustrative embodiments, vehicle use and/or ownership costs can be augmented by advertiser revenue, and trade-offs in time for money can be exchanged over a journey in order to maximize value in accordance with occupant and/or driver/owner constraints and desires. By including the advertiser options in a journey, overall journey value can be improved with minimal imposition on the involved parties.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a destination;
receive advertiser selection criteria;
determine an advertiser route, including an advertiser location, alternative to a fastest or shortest route, based on the advertiser selection criteria;
present the advertiser route to a vehicle occupant;
receive an occupant decision of either acceptance or avoidance of the advertiser route; and
augment an eventual trip cost based on whether the advertiser route was accepted or avoided.

2. The system of claim 1, wherein the advertiser selection criteria includes an acceptable distance deviance.

3. The system of claim 1, wherein the advertiser selection criteria includes an acceptable time deviance.

4. The system of claim 1, wherein the advertiser selection criteria includes driver or vehicle owner defined criteria.

5. The system of claim 1, wherein the advertiser selection criteria includes passenger defined criteria.

6. The system of claim 1, wherein the augmentation includes decreasing a trip cost if an advertiser route was accepted.

7. The system of claim 1, wherein the augmentation includes increasing a trip cost if an advertiser route was avoided.

8. The system of claim 1, wherein the processor is further configured to:
determine if a vehicle is proximate to the advertiser location; and
offer a stop at the advertiser location.

9. The system of claim 8, wherein the augmentation includes decreasing a trip cost based on a value associated with the stop at the advertiser location, if the stop at the advertiser location is accepted by the vehicle occupant.

10. A system comprising:
a processor configured to:
receive a destination;
calculate a direct route to the destination;
find potential advertisers with a predefined proximity to the direct route;
select an advertiser from the potential advertisers for inclusion in an advertiser route;
present the advertiser route to a vehicle passenger with an option to opt-out of the advertiser route; and
increase a travel cost if the passenger elects to opt-out of the advertiser route.

11. The system of claim 10, wherein the predefined proximity includes a distance proximity.

12. The system of claim 10, wherein the predefined proximity includes a temporal proximity.

13. The system of claim 10, wherein the processor is configured to select the advertiser based on a value associated with the advertiser.

14. The system of claim 13, wherein the processor is configured to increase the travel cost based on the value associated with the advertiser.

15. The system of claim 10, wherein the processor is configured to offer a stop at an advertiser location associated with the advertiser when a vehicle is in proximity to the advertiser location.

16. A system comprising:
a processor configured to:
receive a destination;
find advertisers with a predefined proximity to a direct route to the destination;
select an advertiser from the found advertisers for inclusion in an advertiser route;
present the advertiser route to a vehicle passenger with an option to elect the advertiser route;
offer a stop at an advertiser associated location when a vehicle reaches the advertiser associated location; and
decrease a travel cost if the passenger elects the advertiser route.

17. The system of claim 16, wherein the predefined proximity includes a distance proximity.

18. The system of claim 16, wherein the predefined proximity includes a temporal proximity.

19. The system of claim 16, wherein the processor is configured to select the advertiser based on a value associated with the advertiser and the processor is configured to decrease the travel cost based on the value associated with the advertiser.

20. The system of claim 16, wherein the processor is configured to further decrease the travel cost based on a value associated with the offered stop if the offered stop is accepted by the passenger.
